(19) United States
(12) Patent Application Publication
(10) Pub. No.: US 2015/0115495 A1
(43) Pub. Date: Apr. 30, 2015

(54) IMPRINTING METHOD AND APPARATUS

(71) Applicant: Asahi Glass Company, Limited, Chiyoda-ku (JP)

(72) Inventors: Hiroshi SAKAMOTO, Chiyoda-ku (JP); Kosuke TAKAYAMA, Chiyoda-ku (JP); Yuriko KAIDA, Chiyoda-ku (JP)

(73) Assignee: Asahi Glass Company, Limited, Chiyoda-ku (JP)

(21) Appl. No.: 14/593,420

(22) Filed: Jan. 9, 2015

Related U.S. Application Data
(63) Continuation of application No. PCT/JP2013/068432, filed on Jul. 4, 2013.

(30) Foreign Application Priority Data
Jul. 10, 2012 (JP) 2012-154511

(51) Int. Cl. B29C 59/04; B29C 59/00

(52) U.S. Cl. CPC B29C 59/046; B29C 59/002; B29K 2101/12
USPC 264/145; 264/171.13; 425/115

(57) ABSTRACT

An imprinting method includes applying a forming material onto a glass sheet, forming a concavo-convex layer on the glass sheet by holding a layer of the forming material between the glass sheet and a mold and transferring a concavo-convex pattern of the mold to the layer of the forming material, and cutting a laminated sheet including the glass sheet and the concavo-convex layer. The forming material is applied to a position distant from a cutting position of the cutting.

### CROSS-REFERENCE TO RELATED APPLICATIONS

The present application is a continuation application filed under 35 U.S.C. 111(a) claiming benefit under 35 U.S.C. 120 and 365(c) of PCT International Application No. PCT/JP2013/068432, filed on Jul. 4, 2013 and designating the U.S., which claims priority to Japanese Patent Application No. 2012-154511, filed on Jul. 10, 2012. The entire contents of the foregoing applications are incorporated herein by reference.

### BACKGROUND OF THE INVENTION

1. Field of the Invention

The present invention relates to imprinting methods and apparatuses.

2. Description of the Related Art

Imprinting has attracted attention as a technique capable of producing a large number of micro concavo-convex structures at a low cost. According to imprinting, for example, while rotating a roll-shaped mold having a concavo-convex pattern on its periphery (a so-called gravure roll), the concavo-convex pattern of the gravure roll is successively transferred to a surface of a layer of forming material (see, for example, International Publication Pamphlet No. WO 2010/090085).

FIG. 1 is a side view of an imprinting apparatus. A glass sheet 1 and a layer of forming material are held between and delivered by a transfer roller 3 and a gravure roll 4, so that a concavo-convex pattern of the gravure roll 4 is transferred to the layer of forming material. The layer of forming material is pressed against the gravure roll 4 by the tension applied to the glass sheet 1, and gradually hardens while rotating together with the gravure roll 4, so as to become a concavo-convex layer. The concavo-convex layer passes between a separation roller 5 and the gravure roll 4 so as to be separated from the gravure roll 4. As a result, a laminated sheet of the glass sheet 1 and the concavo-convex layer is obtained. The laminated sheet is cut when used.

### SUMMARY OF THE INVENTION

According to an aspect of the present invention, an imprinting method includes applying a forming material onto a glass sheet, forming a concavo-convex layer on the glass sheet by holding a layer of the forming material between the glass sheet and a mold and transferring a concavo-convex pattern of the mold to the layer of the forming material, and cutting a laminated sheet including the glass sheet and the concavo-convex layer. The forming material is applied to a position distant from a cutting position of the cutting.

According to an aspect of the present invention, an imprinting method includes applying a forming material onto a glass sheet having a belt shape and forming a concavo-convex layer on the glass sheet by holding a layer of the forming material between the glass sheet and a mold and transferring a concavo-convex pattern of the mold to the layer of the forming material. The forming material is applied at intervals in a lengthwise direction of the glass sheet.

According to an aspect of the present invention, an imprinting method includes applying a forming material onto a mold, forming a concavo-convex layer on a glass sheet by holding a layer of the forming material between the mold and the glass sheet and transferring a concavo-convex pattern of the mold to the layer of the forming material, and cutting a laminated sheet including the glass sheet and the concavo-convex layer. The forming material is applied to a position distant from a position on the mold corresponding to a cutting position of the glass sheet.

According to an aspect of the present invention, an imprinting method includes applying a forming material onto a mold having a roll shape or an endless belt shape and forming a concavo-convex layer on a glass sheet by holding a layer of the forming material between the mold and the glass sheet and transferring a concavo-convex pattern of the mold to the layer of the forming material. The forming material is applied at intervals along a periphery of the mold.

According to an aspect of the present invention, an imprinting apparatus includes an applicator that applies a forming material onto a glass sheet, a mold having a concavo-convex pattern, and a cutter that cuts a laminated sheet including the glass sheet and a concavo-convex layer. The concavo-convex layer is formed by holding a layer of the forming material between the glass sheet and the mold and transferring the concavo-convex pattern of the mold to the layer of the forming material. The applicator applies the forming material to a position distant from a cutting position of the cutter.

According to an aspect of the present invention, an imprinting apparatus includes an applicator that applies a forming material onto a glass sheet having a belt shape and a mold having a concavo-convex pattern. A concavo-convex layer is formed on the glass sheet by holding a layer of the forming material between the glass sheet and the mold and transferring the concavo-convex pattern of the mold to the layer of the forming material. The applicator applies the forming material at intervals in a lengthwise direction of the glass sheet.

According to an aspect of the present invention, an imprinting apparatus includes a mold having a concavo-convex pattern, an applicator that applies a forming material onto the mold, and a cutter that cuts a laminated sheet including a glass sheet and a concavo-convex layer, the concavo-convex layer being formed by holding a layer of the forming material between the mold and the glass sheet and transferring the concavo-convex pattern of the mold to the layer of the forming material. The applicator applies the forming material to a position distant from a position on the mold corresponding to a cutting position at which the glass sheet is cut by the cutter.

According to an aspect of the present invention, an imprinting apparatus includes a mold having a concavo-convex pattern, the mold having a roll shape or an endless belt shape, an applicator that applies a forming material onto the mold, and a cutter that cuts a laminated sheet including a glass sheet and a concavo-convex layer, the concavo-convex layer being formed by holding a layer of the forming material between the mold and the glass sheet and transferring the concavo-convex pattern of the mold to the layer of the forming material. The applicator applies the forming material at intervals along a periphery of the mold.

The object and advantages of the embodiments will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

Other objects, features and advantages of the present invention will become more apparent from the following detailed description when read in conjunction with the accompanying drawings, in which:

FIG. 1 is a side view of an imprinting apparatus;

FIG. 2 is a side view of an imprinting apparatus according to a first embodiment of the present invention;

FIG. 3 is a cross-sectional view taken along a plane including line II-II of FIG. 2;

FIG. 4 is a cross-sectional view taken along a plane including line of FIG. 2;

FIG. 5 is a cross-sectional view taken along a plane including line IV-IV of FIG. 2;

FIG. 6 is a cross-sectional view taken along a plane including line V-V of FIG. 2;

FIG. 7 is a cross-sectional view taken along a plane including line VI-VI of FIG. 2;

FIG. 8 is a side view of an imprinting apparatus according to a second embodiment of the present invention;

FIG. 9 is a cross-sectional view taken along a plane including line VIII-VIII of FIG. 8;

FIG. 10 is a cross-sectional view taken along a plane including line IX-IX of FIG. 8;

FIG. 11 is a cross-sectional view taken along a plane including line X-X of FIG. 8;

FIG. 12 is a cross-sectional view taken along a plane including line XI-XI of FIG. 8;

FIG. 13 is a cross-sectional view taken along a plane including line XII-XII of FIG. 8;

FIG. 14 is a side view of an imprinting apparatus according to a third embodiment of the present invention;

FIG. 15 is a cross-sectional view taken along a plane including line XIV-XIV of FIG. 14;

FIG. 16 is a cross-sectional view taken along a plane including line XV-XV of FIG. 14;

FIG. 17 is a cross-sectional view taken along a plane including line XVI-XVI of FIG. 14;

FIG. 18 is a cross-sectional view taken along a plane including line XVII-XVII of FIG. 14;

FIG. 19 is a cross-sectional view taken along a plane including line XVIII-XVIII of FIG. 14; and

FIG. 20 is a diagram illustrating a variation of an application method.

### DETAILED DESCRIPTION OF THE PREFERRED EMBODIMENTS

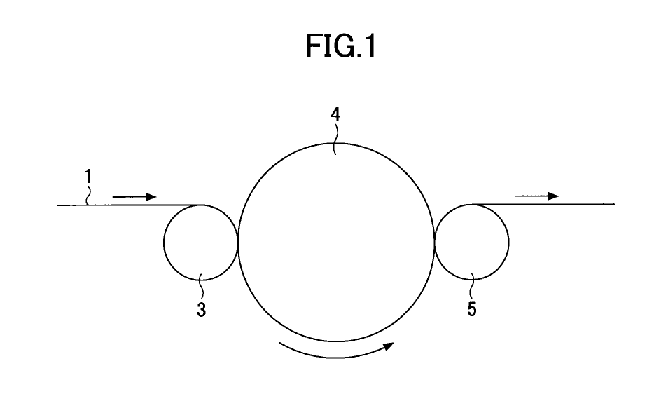

As described above, according to the imprinting apparatus as illustrated in FIG. 1, the obtained laminated sheet is formed of a glass sheet and a concavo-convex layer that greatly differ in hardness. Therefore, the laminated sheet is hard to cut and the cutting accuracy is poor.

According to an aspect of the present invention, an imprinting method and apparatus that enable easy and accurate cutting of laminated sheets are provided.

A description is given below, with reference to the accompanying drawings, of embodiments of the present invention. The same or corresponding configurations are referred to by the same reference numeral or corresponding reference numerals and are not repetitively described.

### First Embodiment

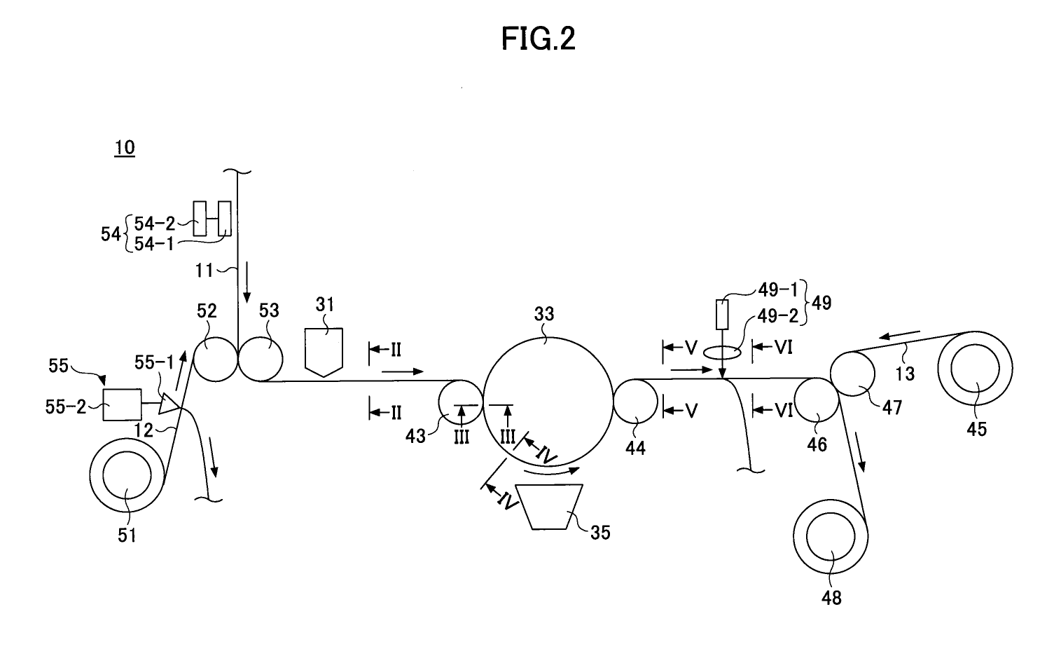

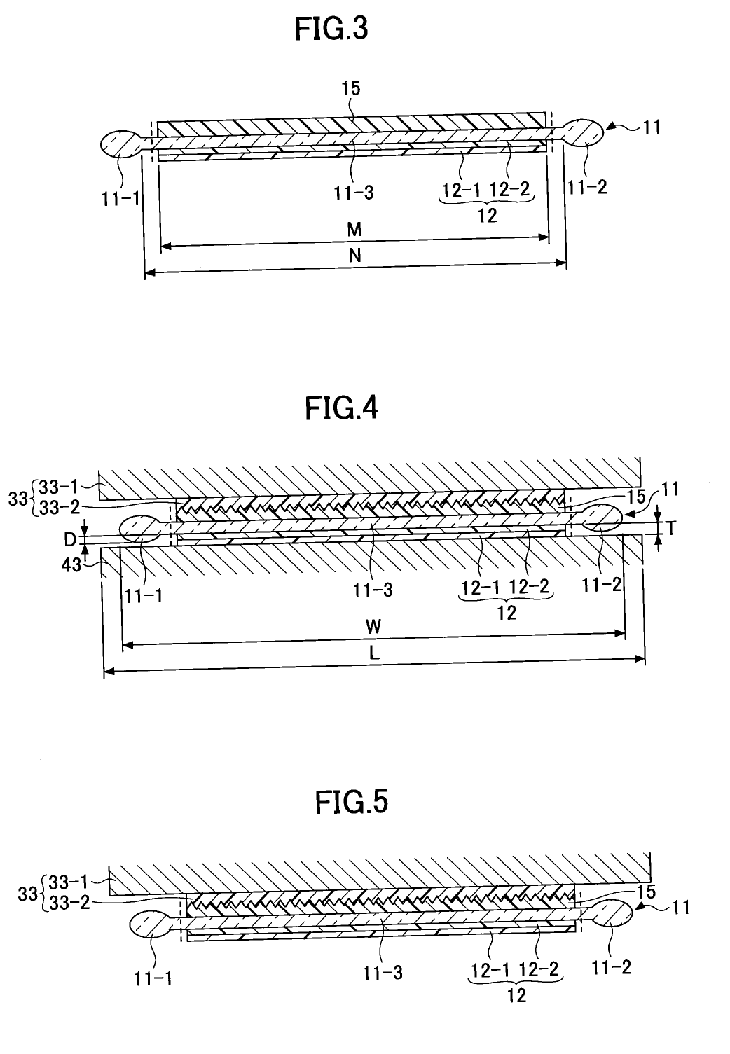

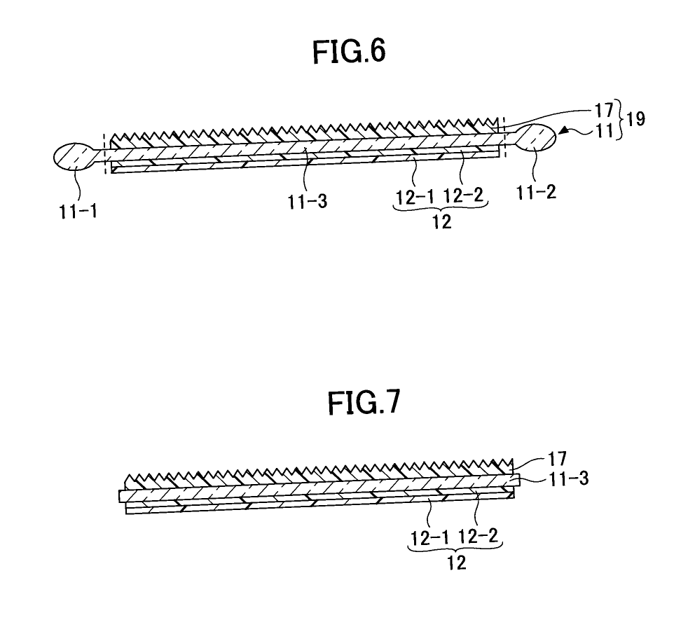

FIG. 2 is a side view of an imprinting apparatus according to a first embodiment of the present invention. FIGS. 3, 4, 5, 6 and 7 are diagrams illustrating an imprinting method according to the first embodiment. FIG. 3 is a cross-sectional view taken along a plane including line II-II of FIG. 2. FIG. 4 is a cross-sectional view taken along a plane including line of FIG. 2. FIG. 5 is a cross-sectional view taken along a plane including line IV-IV of FIG. 2. FIG. 6 is a cross-sectional view taken along a plane including line V-V of FIG. 2. FIG. 7 is a cross-sectional view taken along a plane including line VI-VI of FIG. 2. In FIGS. 3 through 6, broken lines indicate cutting positions in a cutting process.

An imprinting apparatus 10 forms a concavo-convex layer 17 (FIG. 6) on a glass sheet 11. The glass sheet 11 and the concavo-convex layer 17 form a laminated sheet 19. The concavo-convex layer 17 has a concavo-convex pattern of periodically arranged elevations.

Examples of the glass of the glass sheet 11 include alkali-free glass, borosilicate glass, soda-lime glass, high silica glass, and other oxide glasses whose principal component is a silicon oxide.

The method of forming the glass sheet 11 may be a common method, for example, any of the float glass process, the fusion method, and the redraw method. According to these methods, a belt-shaped glass of a desired thickness is formed by holding widthwise end portions of a belt-shaped glass softened by heating and applying tension to the belt-shaped glass in its widthwise directions. The formed glass sheet 11 includes thick parts 11-1 and 11-2 forming its widthwise end portions (right and left end portions in FIGS. 3 through 6) and a thin part 11-3, which is thinner than the thick parts 11-1 and 11-2 and has a uniform thickness, between the thick parts 11-1 and 11-2. The thick parts 11-1 and 11-2 are cut off during the process.

The thickness of the thin part 11-3 of the glass sheet 11 is, for example, 0.3 mm or less, preferably, 0.2 mm or less, more preferably, 0.1 mm or less, and still more preferably, 0.05 mm or less, in light of flexibility. Furthermore, the thickness of the glass sheet 11 is preferably 0.0001 mm or more, more preferably, 0.001 mm or more, and still more preferably, 0.005 mm or more, in light of glass formability.

The imprinting apparatus 10 is, for example, a photoimprinting apparatus, and includes an applicator 31, a roll-shaped mold (gravure roll) 33, a light source 35, a transfer roller 43, a separation roller 44, a feed roller 45, a pair of superposing rollers 46 and 47, a wind-up roller 48, and a laminated sheet cutter 49.

The applicator 31 applies a forming material onto the glass sheet 11 and forms a forming material layer 15 as illustrated in FIG. 3. Examples of the applicator 31 include a die coater, a roll coater, a gravure coater, a spray coater, a flow coater, and a blade coater.

The glass sheet 11 may be subjected in advance to surface treatment in order to increase adhesion between a glass surface and the forming material. Examples of heat treatment include primer treatment, ozone treatment, and plasma etching. A silane coupling agent, silazane or the like is used as a primer.

Examples of forming materials include photopolymers. Common photopolymers used for photoimprinting may be used. Photopolymers are composed of monomers, a photoinitiator, etc. Examples of monomers of a radical polymerization type include acrylic monomers and vinyl monomers. Examples of monomers of an ion polymerization type include epoxy monomers and vinyl ether monomers. The photopolymer is prepared in a liquid state and is applied onto the glass sheet 11 as illustrated in FIG. 3, for example. The forming material may include metal oxide particles.

The gravure roll 33 includes, for example, a metal roll 33-1 and a belt-shaped sheet 33-2 fixed to the periphery of the metal roll 33-1 as illustrated in FIG. 4. The belt-shaped has a concavo-convex pattern. In order to reduce a manufacturing cost, the belt-shaped sheet 33-2 is molded using a master mold and may be duplicated a number of times. Examples of the duplication method include imprinting and electroforming. The master mold is formed by processing a base material by, for example, photolithography or electron-beam lithography. The belt-shaped sheet 33-2 is formed of, for example, metal (such as nickel or chromium) or resin (such as polycarbonate or cyclic olefin resin), and is flexible.

The gravure roll 33 may be formed by forming a concavo-convex pattern on a surface of a metal roll by photolithography or electron-beam lithography.

The gravure roll 33 may be subjected to mold release treatment in order to increase the releasability of the forming material from the mold surface. Examples of mold release treatment include fluorine coating and silicone coating.

The light source 35 emits light to the forming material layer 15 held between the glass sheet 11 and the gravure roll 33 as illustrated in FIGS. 2 and 5 so as to solidify (harden) the forming material layer 15. The concavo-convex layer 17 formed by solidifying the forming material layer 15 has a concavo-convex pattern that is substantially the reverse of the concavo-convex pattern of the gravure roll 33.

Examples of light that hardens photopolymers include ultraviolet radiation, visible radiation, and infrared radiation. Examples of light sources of ultraviolet radiation include ultraviolet fluorescent lamps, ultraviolet LEDs, low-pressure mercury-vapor lamps, high-pressure mercury-vapor lamps, ultra-high-pressure mercury-vapor lamps, xenon lamps, and carbon arc lamps. Examples of light sources of visible radiation include visible light fluorescent lamps, visible light incandescent lamps, and visible light LEDs.

According to photoimprinting, at least one of the glass sheet 11 and the gravure roll 33 may be formed of a light transmitting material. Light emitted from the light source 35 is, for example, transmitted through a transparent resin film 12 and the transparent glass sheet 11 so as to enter the forming material layer 15. Alternatively, the light source 35 may be provided inside the cylindrical gravure roll 33, and light emitted from the light source 35 may be transmitted through the gravure roll 33, which is transparent in this case, so as to enter the forming material layer 15.

According to photoimprinting, forming may be performed at room temperature. Accordingly, a distortion due to the difference between the linear expansion coefficients of the gravure roll 33 and the glass sheet 11, thus resulting in good transfer accuracy. The forming material layer 15 may be heated in order to promote a hardening reaction.

The resin film 12, the glass sheet 11, and the forming material layer 15 are held in this order from the transfer roller 43 side as illustrated in FIG. 4 and delivered by the gravure roll 33 and the transfer roller 43. The gravure roll 33 and the transfer roller 43 are relatively movable toward and away from each other, and one of the gravure roll 33 and the transfer roller 43 may be pressed against the other by a hydro pneumatic cylinder or the like. The transfer roller 43 may be a metal roller peripherally covered with rubber. The elastic deformation of the rubber makes it possible to avoid biting in foreign matter such as dust and to reduce stress concentration due to variations in the thickness of the glass sheet 11. One of the gravure roll 33 and the transfer roller 43 may be driven to rotate by the rotation of the other that is driven to rotate by a rotary motor or the like. When one of the gravure roll 33 and the transfer roller 43 is driven to rotate by the rotation of the other, the difference in circumferential speed between the gravure roll 33 and the transfer roller 43 is limited, so that the shearing stress is limited.

As illustrated in FIG. 5, the forming material layer 15 is pressed against the gravure roll 33 by the tension applied to the glass sheet 11 so as to rotate with the gravure roll 33 until being pulled out from between the gravure roll 33 and the separation roller 44 after being inserted between the gravure roll 33 and the transfer roller 43. While rotating with the gravure roll 33, the forming material layer 15 gradually solidifies to become the concavo-convex layer 17. The direction of the tension of the glass sheet 11 is a direction in which the glass sheet 11 moves.

The resin film 12, the glass sheet 11, and the concavo-convex layer 17 are held in this order from the separation roller 44 side and delivered by the gravure roll 33 and the separation roller 44. The gravure roll 33 and the separation roller 44 are relatively movable toward and away from each other, and one of the gravure roll 33 and the separation roller 44 may be pressed against the other by a hydro pneumatic cylinder or the like. The separation roller 44 may be a metal roller peripherally covered with rubber. One of the gravure roll 33 and the separation roller 44 may be driven to rotate by the rotation of the other that is driven to rotate by a rotary motor or the like. When one of the gravure roll 33 and the separation roller 44 is driven to rotate by the rotation of the other, the difference in circumferential speed between the gravure roll 33 and the separation roller 44 is limited, so that the shearing stress is limited.

The axial directions of the gravure roll 33, the axial directions of the transfer roller 43, and the axial directions of the separation roller 44 are parallel to the widthwise directions of the glass sheet 11. An axial length of the gravure roll 33, an axial length L (FIG. 4) of the transfer roller 43, and an axial length of the separation roller 44 may each be greater than a width W (FIG. 4) of the glass sheet 11.

A protection sheet roll, which is a spirally rolled-up concavo-convex protection sheet 13, is attached to the feed roller 45. When the feed roller 45 rotates, the concavo-convex protection sheet 13 is fed out from the protection sheet roll. The concavo-convex protection sheet 13 is formed of a resin film, paper or the like.

The superposing rollers 46 and 47 superpose the concavo-convex protection sheet 13 fed out from the protection sheet roll and the laminated sheet 19 on top of each other. The laminated sheet 19 is composed of the glass sheet 11 and the concavo-convex layer 17.

The concavo-convex protection sheet 13 is bent and deformed along the superposing roller 47. As a result, the concavo-convex protection sheet 13 and the laminated sheet 19 gradually merge together, so that it is possible to prevent the generation of wrinkles or the involvement of air at the time of superposing the concavo-convex protection sheet 13 and the laminated sheet 19.

The concavo-convex protection sheet 13 may be provided with adhesive to be bonded to the laminated sheet 19 or may solely contact the laminated sheet 19 without being bonded to the laminated sheet 19.

The concavo-convex protection sheet 13 covers the concavo-convex layer 17 of the laminated sheet 19 so as to prevent adhesion of foreign matter (such as dust) or damage to the concavo-convex layer 17.

The wind-up roller 48 winds up a lamination of the laminated sheet 19, the resin film 12, and the concavo-convex protection sheet 13 so as to produce a product roll. The outermost layer of the product roll may be either the resin film 12 or the concavo-convex protection sheet 13. With either the resin film 12 or the concavo-convex protection sheet 13, the adhesion of foreign matter and damage to the laminated sheet 19 are less likely to occur during the storage of the product roll.

The laminated sheet cutter 49 cuts off the thick parts 11-1 and 11-2 of the glass sheet 11 by cutting the laminated sheet 19. At this time, the laminated sheet cutter 49 may cut off part of the thin part 11-3 together with the thick parts 11-1 and 11-2. Because a remaining portion of the thin part 11-3 uniform in thickness is wound up by the wind-up roller 48, a gap is less likely to be formed inside the product roll, so that it is possible to prevent the product roll from losing shape. Furthermore, the internal stress of the product roll is less likely to be uneven, so that the glass sheet 11 is less likely to be broken.

The laminated sheet cutter 49 includes, for example, a laser light source 49-1 and an optical system (such as a lens) 49-2 that irradiates the laminated sheet 19 with laser light emitted from the laser light source 49-1. The laminated sheet cutter 49 cuts the laminated sheet 19 with a thermal stress generated by irradiation with the laser light.

The laminated sheet 19 is composed of the glass sheet 11 and the concavo-convex layer 17. The hardness of the glass sheet 11 and the hardness of the concavo-convex layer 17 greatly differ. The position of the concavo-convex layer 17 on the glass sheet 11 is basically determined by the position of application of the forming material.

Therefore, the applicator 31 applies the forming material to a position distant from the cutting positions of the laminated sheet cutter 49 as illustrated in FIG. 3. That is, the applicator 31 does not apply the forming material to the cutting positions of the laminated sheet cutter 49 and their vicinity (for example, within 5 mm from each cutting position). For example, the applicator 31 applies the forming material inside the widthwise ends of the thin part 11-3. The width of the forming material layer 15 is narrower than a width N of the thin part 11-3.

As a result, as illustrated in FIG. 6, the concavo-convex layer 17 is formed inside the widthwise ends of the thin part 11-3, and is formed at a position distant from the cutting positions of the laminated sheet cutter 49.

By cutting the glass sheet 11 alone, the laminated sheet cutter 49 can cut the laminated sheet 19 without cutting the concavo-convex layer 17 that greatly differs in hardness from the glass sheet 11. Therefore, it is possible to employ a commonly used glass cutting method as a method of cutting the laminated sheet 19, so that it is possible to cut the laminated sheet 19 with ease and accuracy.

The configuration of the laminated sheet cutter 49 is not limited in particular. For example, the laminated sheet cutter 49 may include a scribe cutter that forms scribe lines on the glass sheet 11 and a bending and folding machine that cuts the glass sheet 11 along the scribe lines formed by the scribe cutter.

The applicator 31 may apply the forming material to the thick parts 11-1 and 11-2 as long as the forming material is applied to a position distant from the cutting positions of the laminated sheet cutter 49.

The imprinting apparatus 10 may further include a feed roller 51, a pair of bonding rollers 52 and 53, a glass sheet thickness distribution measuring apparatus 54, and a resin film cutter 55.

A film roll into which the resin film 12 is spirally rolled up is attached to the feed roller 51. The feed roller 51 rotates to feed the resin film 12 from the film roll.

The resin film 12 is composed of, for example, a base material 12-1 and an adhesive layer 12-2 formed on the base material 12-1 as illustrated in FIG. 3, and is bonded to the glass sheet 11 with the adhesive force of the adhesive layer 12-2.

Examples of the base material 12-1 include homopolymers and copolymers such as polyethylene, polypropylene, polyvinyl chloride, polystyrene, polyester, and polyamide.

Examples of the adhesive of the adhesive layer 12-2 include vinyl acetate adhesives, acetal adhesives, acrylic adhesives, polyamide adhesives, polyester adhesives, polyurethane adhesives, and rubber adhesives.

The resin film 12 may alternatively be joined to the glass sheet 11 by thermocompression bonding, and accordingly, does not have to include the adhesive layer 12-2. The temperature of the glass sheet 11 fed from a glass forming apparatus is higher than room temperature, and is subjectable to thermocompression bonding. Thus, the bonding method is not limited in particular.

The resin film 12 fed from the film roll and the glass sheet 11 are held between and delivered by the bonding rollers 52 and 53, so that the resin film 12 is bonded to a surface of the glass sheet 11 opposite to a surface on which the forming material layer 15 is to be formed. The resin film 12 reinforces the glass sheet 11, which is brittle, so as to prevent breakage of the glass sheet 11.

The glass sheet is successively fed from a glass forming apparatus. The glass sheet 11 includes the thick parts 11-1 and 11-2 forming its widthwise end portions (right and left end portions in FIGS. 3 through 6) and the thin part 11-3, which is thinner than the thick parts 11-1 and 11-2 and has a uniform thickness, between the thick parts 11-1 and 11-2.

Therefore, the bonding rollers 52 and 53 bond the resin film 12 narrower in width than the glass sheet 11 to the thin part 11-3 of the glass sheet 11 having a uniform thickness without bonding the resin film 12 to the thick parts 11-1 and 11-2. As illustrated in FIG. 4, the resin film 12 fills in the gap between the thin part 11-3 of the glass sheet 11 and the transfer roller 43 in the transfer process. This increases a pressure acting on the forming material on the thin part 11-3 and causes the pressure to be evenly distributed. As a result, it is possible to transfer the concavo-convex pattern of the gravure roll 33 onto the forming material layer 15 with accuracy.

A thickness T (FIG. 4) of the resin film 12 is preferably greater than a difference in level D (FIG. 4) between the thick parts 11-1 and 11-2 and the thin part 11-3 (T>D), and more preferably, greater than double the level difference D (T>2×D). When the expression T>2×D holds, it is possible to ensure an increase in the pressure acting on the forming material between the thin part 11-3 and the gravure roll 33. When the belt-shaped sheet 33-2 of the gravure roll 33 is narrower in width than the thin part 11-3, it is satisfactory if the expression T>D holds.

The glass sheet thickness distribution measuring apparatus 54 measures a widthwise thickness distribution of the glass sheet 11. The glass sheet thickness distribution measuring apparatus 54 includes, for example, a thickness measuring unit 54-1 that measures the thickness of the glass sheet 11 and a drive part 54-2 that moves the thickness measuring unit 54-1 in the widthwise directions of the glass sheet 11. For example, an interference thickness meter, a β-ray thickness gauge or the like may be employed as the thickness measuring unit 54-1.

The glass sheet thickness distribution measuring apparatus 54 may alternatively include multiple thickness measuring units 54-1 that are arranged in the widthwise directions of the glass sheet 11. In this case, the drive unit 54-2 may be omitted.

The resin film cutter 55 includes a cutter 55-1 that cuts the resin film 12 and a motor 55-2 that moves the cutter 55-1 in the widthwise directions of the glass sheet 11. A laser may be used in place of the cutter 55-1.

The resin film cutter 55 cuts the resin film 12 to be bonded to the glass sheet 11 based on the measurement result of the glass sheet thickness distribution measuring apparatus 54 so as to adjust a width M (FIG. 3) of the resin film 12. For example, the resin film cutter 55 calculates the width N of the thin part 11-3 of the glass sheet 11 based on the measurement result of the glass sheet thickness distribution measuring apparatus 54, and adjusts the width M of the resin film 12 based on the calculation result. This makes it possible to bond the resin film 12 to only the thin part 11-3 when the width N of the thin part 11-3 varies.

The imprinting apparatus 10 may further include a position adjustment mechanism that adjusts the positions of the glass sheet 11 and the resin film 12 in the widthwise directions by moving the glass sheet 11 or the resin film 12 widthwise before the glass sheet 11 and the resin film 12 are bonded. The position adjustment mechanism make an adjustment based on the position of the glass sheet 11 measured with the glass sheet thickness distribution measuring apparatus 54.

Next, a description is given of operations (an imprinting method) of the imprinting apparatus 10 of the above-described configuration. Various operations of the imprinting apparatus 10 are performed under the control of a controller that includes a microcomputer. In the following description, various operations of the imprinting apparatus 10 are described mainly with reference to part of the glass sheet 11 for convenience of description.

First, the glass sheet thickness distribution measuring apparatus 54 measures the width W of the glass sheet 11 successively fed from a glass forming apparatus. The resin film cutter 55 cuts the resin film 12 fed from the film roll based on the measurement result so as to adjust the width M of the resin film 12. It is possible to accommodate variations in the width N of the thin part 11-3 of the glass sheet 11.

Next, the bonding rollers 52 and 53 hold and deliver the resin film 12 and the glass sheet 11, so that the resin film 12 is bonded to a surface of the glass sheet 11 opposite to a surface on which the forming material layer 15 is to be formed. The resin film 12 reinforces the brittle glass sheet 11 so as to prevent breakage of the glass sheet 11. The bonding rollers 52 and 53 bond the resin film 12 to the thin part 11-3 of the glass sheet 11 having a uniform thickness.

Next, as illustrated in FIG. 3, the applicator 31 applies the forming material on the glass sheet 11, so that the forming material layer 15 is formed. The forming material layer 15 is provided on a surface of the glass sheet 11 opposite to the surface to which the resin film 12 is bonded.

The applicator 31 applies the forming material to a position distant from the cutting positions of the laminated sheet cutter 49. For example, the applicator 31 applies the forming material inside the widthwise ends of the thin part 11-3. The width of the forming material layer 15 is narrower than the width of the width N of the thin part 11-3.

Next, as illustrated in FIG. 4, the resin film 12, the glass sheet 11, and the forming material layer 15 are held in this order from the transfer roller 43 side and delivered by the gravure roll 33 and the transfer roller 43. At this point, the resin film 12 fills in the gap between the thin part 11-3 of the glass sheet 11 and the transfer roller 43. This increases a pressure acting on the forming material on the thin part 11-3 and causes the pressure to be evenly distributed. As a result, it is possible to transfer the concavo-convex pattern of the gravure roll 33 onto the forming material layer 15 with accuracy.

As illustrated in FIG. 5, the forming material layer 15 is pressed against the gravure roll 33 by the tension applied to the glass sheet 11 so as to rotate with the gravure roll 33 until being pulled out from between the gravure roll 33 and the separation roller 44 after being inserted between the gravure roll 33 and the transfer roller 43. While rotating with the gravure roll 33, the forming material layer 15 is exposed to light from the light source 35 so as to gradually solidify and become the concavo-convex layer 17.

Next, the resin film 12, the glass sheet 11, and the concavo-convex layer 17 are held in this order from the separation roller 44 side and delivered by the gravure roll 33 and the separation roller 44.

As illustrated in FIG. 2, the resin film 12, the glass sheet 11, and the concavo-convex layer 17 are bent and deformed along the separation roller 44 so as to be separated from the gravure roll 33.

Thus, the laminated sheet 19 including the glass sheet 11 and the concavo-convex layer 17 is obtained as illustrated in FIG. 6. The concavo-convex layer 17 is formed inside the widthwise ends of the thin part 11-3, and is formed at a position distant from the cutting positions of the laminated sheet cutter 49.

Accordingly, by cutting the glass sheet 11 alone, the laminated sheet cutter 49 can cut the laminated sheet 19 without cutting the concavo-convex layer 17 that greatly differs in hardness from the glass sheet 11. Therefore, it is possible to employ a commonly used glass cutting method as a method of cutting the laminated sheet 19, so that it is possible to cut the laminated sheet 19 with ease and accuracy.

The laminated sheet cutter 49 cuts off the thick parts 11-1 and 11-2 of the glass sheet 11 by cutting the glass sheet 11 as illustrated in FIG. 7, for example. At this time, the laminated sheet cutter 49 may cut off part of the thin part 11-3 together with the thick parts 11-1 and 11-2.

Next, the superposing rollers 46 and 47 superpose the concavo-convex protection sheet 13 fed out from the protection sheet roll and the laminated sheet 19 on top of each other. The concavo-convex protection sheet 13 is formed of a resin film, paper or the like. The concavo-convex protection sheet 13 covers the concavo-convex layer 17 of the laminated sheet 19 so as to prevent adhesion of foreign matter (such as dust) or damage to the concavo-convex layer 17.

Next, the wind-up roller 48 winds up a lamination of the laminated sheet 19, the resin film 12, and the concavo-convex protection sheet 13 so as to produce a product roll. The wind-up roller 48 winds up the thin part 11-3 having a uniform thickness alone. A gap is less likely to be formed inside the product roll, so that it is possible to prevent the product roll from losing shape. Furthermore, the internal stress of the product roll is less likely to be uneven, so that the glass sheet 11 is less likely to be broken.

At the time of use, the laminated sheet 19 is fed from the product roll to be cut to a predetermined size, and is used for producing, for example, optical panels such as liquid crystal panels and organic EL panels. The resin film 12 and the concavo-convex protection sheet 13 may be removed from the laminated sheet 19 during the production process of optical panels and do not have to be components of optical panels.

When used for production of optical panels, the laminated sheet 19 may be used as a moth-eye anti-reflection sheet, a polarizing sheet, a microlens array sheet, a lenticular sheet or the like. The laminated sheet 19 may also be used for production of immunological analysis chips, DNA separation chips, microreactors, etc. The laminated sheet 19 is not limited to particular use.

As described above, according to this embodiment, the applicator 31 applies the forming material to a position distant from the cutting positions of the laminated sheet cutter 49. By cutting the glass sheet alone, the laminated sheet cutter 49 can cut the laminated sheet 19 without cutting the concavo-convex layer 17 that greatly differs in hardness from the glass sheet 11. Accordingly, it is possible to employ a commonly used glass cutting method as a method of cutting the laminated sheet 19, so that it is possible to cut the laminated sheet 19 with ease and accuracy.

The laminated sheet cutter 49 cuts off the thick parts 11-1 and 11-2 of the glass sheet 11 by cutting the laminated sheet 19. Because a remaining portion of the thin part 11-3 uniform in thickness is wound up by the wind-up roller 48, a gap is less likely to be formed inside the product roll, so that it is possible to prevent the product roll from losing shape. Furthermore, the internal stress of the product roll is less likely to be uneven, so that the glass sheet 11 is less likely to be broken.

### Second Embodiment

According to the above-described first embodiment, imprinting is performed using a roll-shaped mold (the gravure roll 33).

In contrast, a second embodiment is different from the first embodiment in performing imprinting using an endless belt-shaped mold. A description is basically given below of differences from the first embodiment.

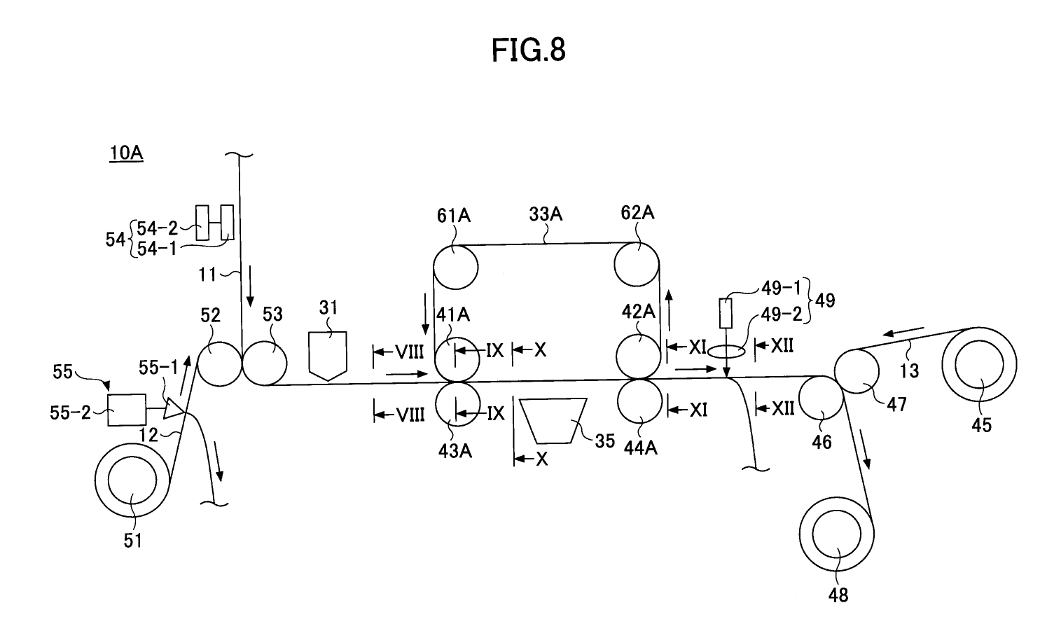

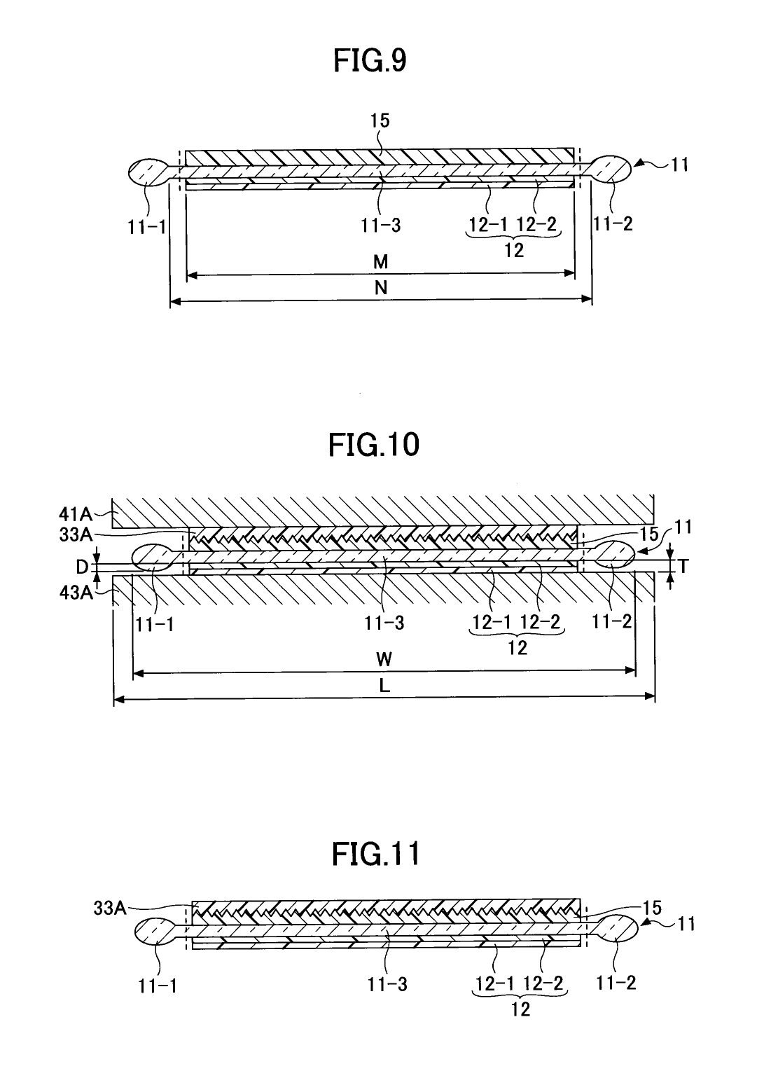

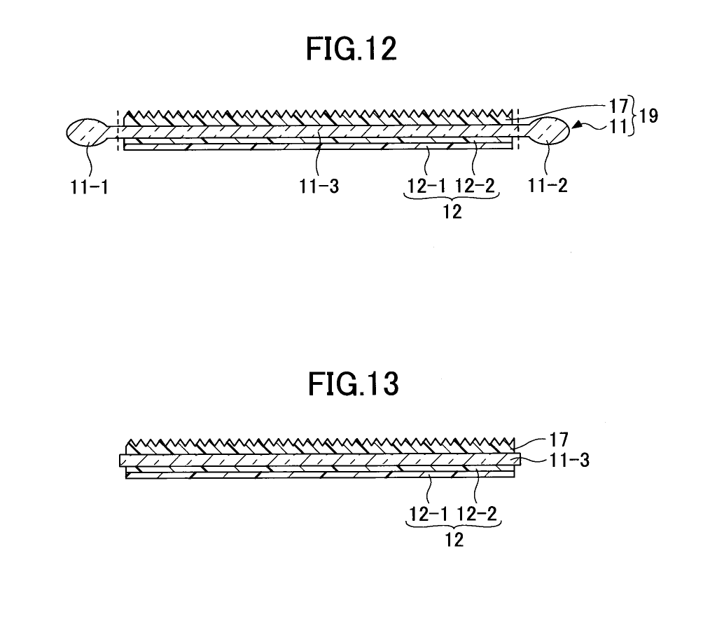

FIG. 8 is a side view of an imprinting apparatus according to the second embodiment of the present invention. FIGS. 9, 10, 11, 12 and 13 are diagrams illustrating an imprinting method according to the second embodiment. FIG. 9 is a cross-sectional view taken along a plane including line VIII-VIII of FIG. 8. FIG. 10 is a cross-sectional view taken along a plane including line IX-IX of FIG. 8. FIG. 11 is a cross-sectional view taken along a plane including line X-X of FIG. 8. FIG. 12 is a cross-sectional view taken along a plane including line XI-XI of FIG. 8. FIG. 13 is a cross-sectional view taken along a plane including line XII-XII of FIG. 8. In FIGS. 9 through 12, broken lines indicate cutting positions in a cutting process.

An imprinting apparatus 10A forms the concavo-convex layer 17 (FIG. 12) on the glass sheet 11. The glass sheet 11 and the concavo-convex layer 17 form the laminated sheet 19. The concavo-convex layer 17 has a concavo-convex pattern of periodically arranged elevations.

Like the imprinting apparatus 10 of the first embodiment, the imprinting apparatus 10A includes the applicator 31, the light source 35, the feed roller 45, the superposing rollers 46 and 47, the wind-up roller 48, the laminated sheet cutter 49, the feed roller 51, the bonding rollers 52 and 53, the glass sheet thickness distribution measuring apparatus 54, and the resin film cutter 55.

Unlike the imprinting apparatus 10 of the first embodiment, the imprinting apparatus 10A includes an endless belt-shaped mold 33A, multiple (for example, two) rotating rollers 41A and 42A, and multiple (for example, two) nip rollers 43A and 44A.

The mold 33A has a concavo-convex pattern to be transferred to a surface of the forming material layer 15 on its periphery. The mold 33A may be subjected to mold release treatment in order to increase the releasability of the forming material from the mold surface. Examples of mold release treatment include fluorine coating and silicone coating.

The mold 33A is wrapped around the rotating rollers 41A and 42A and multiple auxiliary rollers 61A and 62A so as to rotate. The mold 33A is formed of, for example, metal (such as nickel or chromium) or resin (such as polycarbonate or cyclic olefin resin), and is flexible. One or more of the auxiliary rollers 61A and 62A may be omitted.

The mold 33A is formed by welding both ends of a belt-shaped sheet molded using a master mold, and may be duplicated a number of times. Examples of the duplication method include imprinting and electroforming. The master mold is formed by processing a base material by, for example, photolithography or electron-beam lithography.

The resin film 12, the glass sheet 11, the forming material layer 15, and the mold 33A are held in this order from the nip roller 43A side and delivered by the rotating roller 41A and the nip roller 43A. The rotating roller 41A and the nip roller 43A are relatively movable toward and away from each other, and one of the rotating roller 41A and the nip roller 43A may be pressed against the other by a hydro pneumatic cylinder or the like. At least one of the rotating roller 41A and the nip roller 43A may be a metal roller peripherally covered with rubber. The elastic deformation of the rubber makes it possible to avoid biting in foreign matter such as dust and to reduce stress concentration due to variations in the thickness of the glass sheet 11. One of the rotating roller 41A and the nip roller 43A may be driven to rotate by the rotation of the other that is driven to rotate by a rotary motor or the like. When one of the rotating roller 41A and the nip roller 43A is driven to rotate by the rotation of the other, the difference in circumferential speed between the rotating roller 41A and the nip roller 43A is limited, so that the shearing stress is limited.

The glass sheet 11 and the mold 33A hold the forming material layer 15 with the tension of the glass sheet 11 and the tension of the mold 33A and move together with the forming material layer 15 until being pulled out from between the rotating roller 42A and the nip roller 44A after being inserted between the rotating roller 41A and the nip roller 43A. During this time, the forming material layer 15 is exposed to light from the light source 35 so as to gradually solidify and become the concavo-convex layer 17. The concavo-convex layer 17 has a concavo-convex pattern that is substantially the reverse of the concavo-convex pattern of the mold 33A. The direction of the tension of the glass sheet 11 is a direction in which the glass sheet 11 moves. The direction of the tension of the mold 33A is a direction in which the mold 33A moves (rotates).

According to photoimprinting, at least one of the mold 33A and the glass sheet 11 is formed of a light transmitting material. Light emitted from the light source 35 is, for example, transmitted through the transparent resin film 12 and the transparent glass sheet 11 so as to enter the forming material layer 15 as illustrated in FIGS. 8 and 11. Alternatively, the mold 33A may be transparent and light emitted from the light source 35 may be transmitted through the transparent mold 33A so as to enter the forming material layer 15.

The resin film 12, the glass sheet 11, the concavo-convex layer 17, and the mold 33A are held in this order from the nip roller 44A side and delivered by the rotating roller 42A and the nip roller 44A. The rotating roller 42A and the nip roller 44A are relatively movable toward and away from each other, and one of the rotating roller 42A and the nip roller 44A may be pressed against the other by a hydro pneumatic cylinder or the like. At least one of the rotating roller 42A and the nip roller 44A may be a metal roller peripherally covered with rubber. One of the rotating roller 42A and the nip roller 44A may be driven to rotate by the rotation of the other that is driven to rotate by a rotary motor or the like. When one of the rotating roller 42A and the nip roller 44A is driven to rotate by the rotation of the other, the difference in circumferential speed between the rotating roller 42A and the nip roller 44A is limited, so that the shearing stress is limited.

The rotating rollers 41A and 42A and the nip rollers 43A and 44A may have the same outside diameter or different outside diameters.

Next, a description is given of operations (an imprinting method) of the imprinting apparatus 10A of the above-described configuration. Various operations of the imprinting apparatus 10A are performed under the control of a controller that includes a microcomputer. In the following description, various operations of the imprinting apparatus 10A are described mainly with reference to part of the glass sheet 11 for convenience of description.

First, the glass sheet thickness distribution measuring apparatus 54 measures a widthwise thickness distribution of the glass sheet 11 successively fed from a glass forming apparatus. The resin film cutter 55 cuts the resin film 12 fed from the film roll based on the measurement result of the glass sheet thickness distribution measuring apparatus 54 so as to adjust the width M (FIG. 9) of the resin film 12. The thickness M of the resin film 12 is adjusted based on the width N (FIG. 9) of the thin part 11-3 of the glass sheet 11. This makes it possible to bond the resin film 12 to only the thin part 11-3 when the width N of the thin part 11-3 varies.

Next, the resin film 12 and the glass sheet 11 are held between and delivered by the bonding rollers 52 and 53, so that the resin film 12 is bonded to a surface of the glass sheet 11 opposite to a surface on which the forming material layer 15 is to be formed. The resin film 12 reinforces the brittle glass sheet 11 so as to prevent breakage of the glass sheet 11. The bonding rollers 52 and 53 bond the resin film 12 to the thin part 11-3 of the glass sheet 11.

Next, as illustrated in FIG. 9, the applicator 31 applies the forming material on the glass sheet 11, so that the forming material layer 15 is formed. The forming material layer 15 is provided on a surface of the glass sheet 11 opposite to the surface to which the resin film 12 is bonded.

The applicator 31 applies the forming material to a position distant from the cutting positions of the laminated sheet cutter 49, and does not apply the forming material to the cutting positions of the laminated sheet cutter 49 and their vicinity. For example, the applicator 31 applies the forming material inside the widthwise ends of the thin part 11-3. The width of the forming material layer 15 is narrower than the width N (FIG. 9) of the thin part 11-3.

Next, as illustrated in FIG. 10, the resin film 12, the glass sheet 11, the forming material layer 15, and the mold 33A are held in this order from the nip roller 43A side and delivered by the rotating roller 41A and the nip roller 43A. At this point, the resin film 12 fills in the gap between the thin part 11-3 of the glass sheet 11 and the nip roller 43A. This increases a pressure acting on the forming material on the thin part 11-3 and causes the pressure to be evenly distributed. As a result, it is possible to transfer the concavo-convex pattern of the mold 33A onto the forming material layer 15 with accuracy.

At this point, the thickness T of the resin film 12 is preferably greater than the level difference D between the thick parts 11-1 and 11-2 and the thin part 11-3 (T>D), and more preferably, greater than double the level difference D (T>2×D). When the expression T>2×D holds, it is possible to ensure an increase in the pressure acting on the forming material between the thin part 11-3 and the mold 33A. When the mold 33A is narrower in width than the thin part 11-3, it is satisfactory if the expression T>D holds.

As illustrated in FIG. 8, the resin film 12, the glass sheet 11, and the forming material layer 15 are in a flat state when inserted between the rotating roller 41A and the nip roller 43A. On the other hand, the mold 33A is inserted between the rotating roller 41A and the nip roller 43A while being bent and deformed along the rotating roller 41A so as not to bite in air between the forming material layer 15 and the mold 33A, so as to come into close contact with the forming material layer 15.

As illustrated in FIG. 11, the glass sheet 11 and the mold 33A hold the forming material layer 15 with the tension of the glass sheet 11 and the tension of the mold 33A and move together with the forming material layer 15 until being pulled out from between the rotating roller 42A and the nip roller 44A after being inserted between the rotating roller 41A and the nip roller 43A. During this time, the forming material layer 15 is exposed to light from the light source 35 so as to gradually solidify and become the concavo-convex layer 17.

Next, the resin film 12, the glass sheet 11, and the concavo-convex layer 17 are held in this order from the nip roller 44A side and delivered by the rotating roller 42A and the nip roller 44A.

As illustrated in FIG. 8, the resin film 12, the glass sheet 11, and the concavo-convex layer 17 are pulled out from between the rotating roller 42A and the nip roller 44A while being in a flat state. On the other hand, the mold 33A is bent and deformed along the rotating roller 42A for smooth separation from the concavo-convex layer 17.

Thus, the laminated sheet 19 including the glass sheet 11 and the concavo-convex layer 17 is obtained as illustrated in FIG. 12. The concavo-convex layer 17 is formed inside the widthwise ends of the thin part 11-3, and is formed at a position distant from the cutting positions of the laminated sheet cutter 49.

Accordingly, by cutting the glass sheet 11 alone, the laminated sheet cutter 49 can cut the laminated sheet 19 without cutting the concavo-convex layer 17 that greatly differs in hardness from the glass sheet 11. It is possible to employ a commonly used glass cutting method as a method of cutting the laminated sheet 19, so that it is possible to cut the laminated sheet 19 with ease and accuracy.

The laminated sheet cutter 49 cuts off the thick parts 11-1 and 11-2 of the glass sheet 11 by cutting the glass sheet 11 as illustrated in FIG. 13, for example. At this time, the laminated sheet cutter 49 may cut off part of the thin part 11-3 together with the thick parts 11-1 and 11-2.

Next, the superposing rollers 46 and 47 superpose the concavo-convex protection sheet 13 fed out from the protection sheet roll and the laminated sheet 19 on top of each other. The concavo-convex protection sheet 13 is formed of a resin film, paper or the like. The concavo-convex protection sheet 13 covers the concavo-convex layer 17 of the laminated sheet 19 so as to prevent adhesion of foreign matter such as dust or damage to the concavo-convex layer 17.

Next, the wind-up roller 48 winds up a lamination of the laminated sheet 19, the resin film 12, and the concavo-convex protection sheet 13 so as to produce a product roll. Because the thick parts 11-1 and 11-2 of the glass sheet 11 are cut off, a gap is less likely to be formed inside the product roll, so that it is possible to prevent the product roll from losing shape. Furthermore, the internal stress of the product roll is less likely to be uneven, so that the glass sheet 11 is less likely to be broken.

According to this embodiment, like in the first embodiment, the applicator 31 applies the forming material to a position distant from the cutting positions of the laminated sheet cutter 49. By cutting the glass sheet alone, the laminated sheet cutter 49 can cut the laminated sheet 19 without cutting the concavo-convex layer 17 that greatly differs in hardness from the glass sheet 11. Accordingly, it is possible to employ a commonly used glass cutting method as a method of cutting the laminated sheet 19, so that it is possible to cut the laminated sheet 19 with ease and accuracy.

Furthermore, according to this embodiment, the laminated sheet cutter 49 cuts off the thick parts 11-1 and 11-2 of the glass sheet 11 by cutting the laminated sheet 19. Because the thin part 11-3 uniform in thickness is wound up by the wind-up roller 48, a gap is less likely to be formed inside the product roll, so that it is possible to prevent the product roll from losing shape. Furthermore, the internal stress of the product roll is less likely to be uneven, so that the glass sheet 11 is less likely to be broken.

Furthermore, according to this embodiment, the glass sheet 11 passes between the rotating rollers 41A and 42A and the nip rollers 43A and 44A while being in a flat state. Therefore, the brittle glass sheet 11 is kept flat at the time of transfer of the concavo-convex pattern of the mold 33A and at the time of separation of the mold 33A and the concavo-convex layer 17. Accordingly, it is possible to further prevent the breakage of the glass sheet 11.

### Third Embodiment

According to the above-described second embodiment, a concavo-convex layer is formed on one side of the glass sheet 11 using an endless belt-shaped mold.

In contract, a third embodiment is different from the second embodiment in forming a concavo-convex layer on each side of the glass sheet 11 using a pair of endless belt-shaped molds. A description is basically given below of differences from the second embodiment.

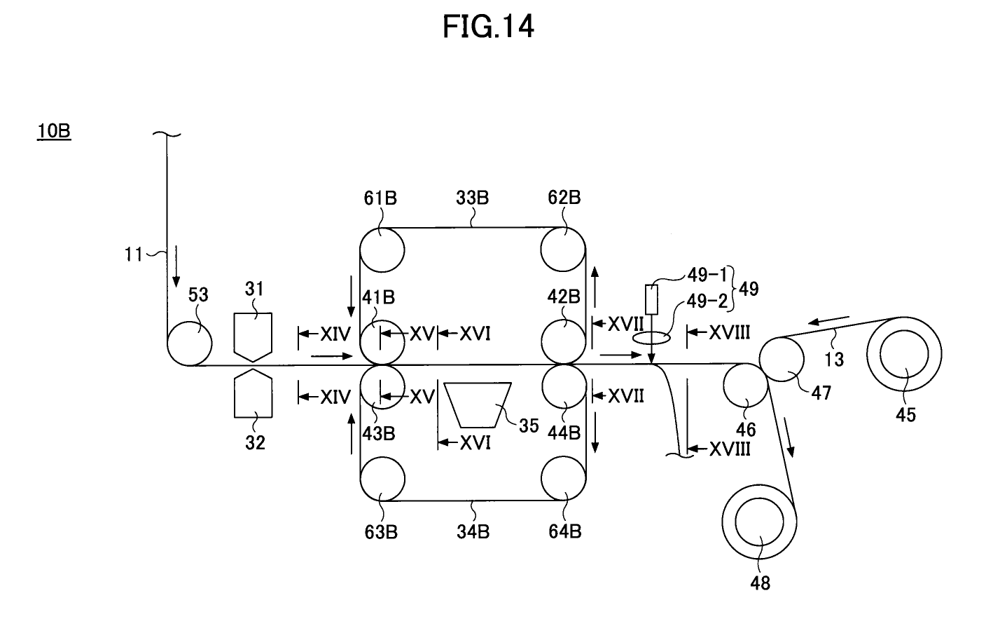

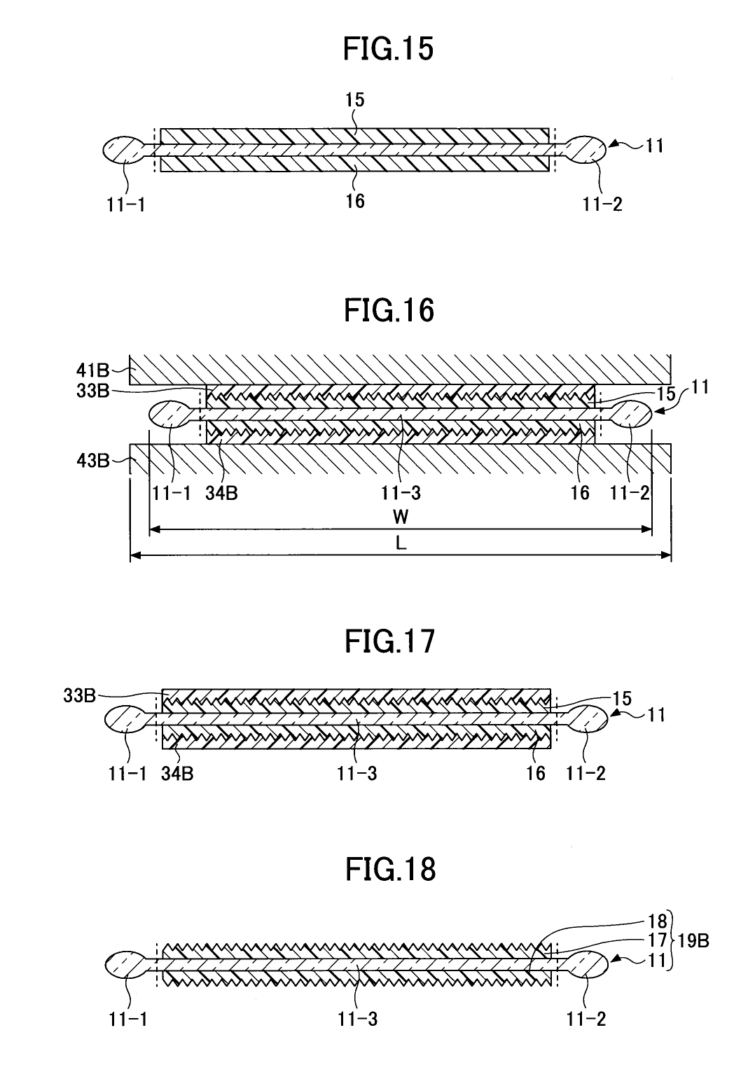

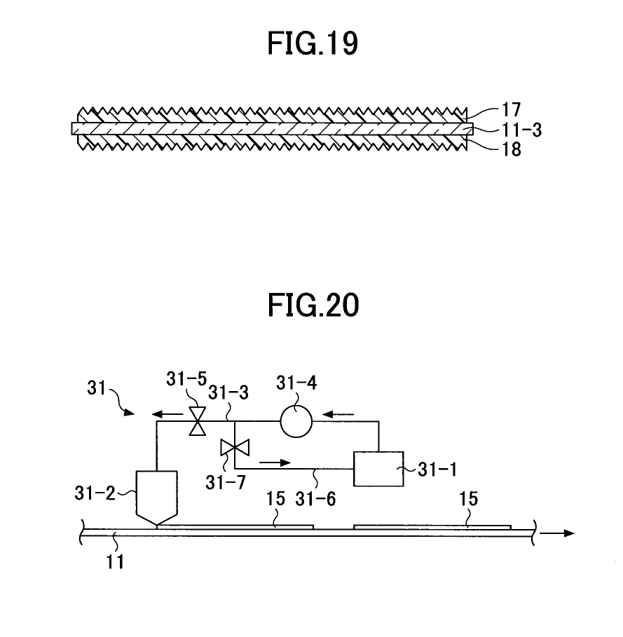

FIG. 14 is a side view of an imprinting apparatus according to the third embodiment of the present invention. FIGS. 15, 16, 17, 18 and 19 are diagrams illustrating an imprinting method according to the third embodiment. FIG. 15 is a cross-sectional view taken along a plane including line XIV-XIV of FIG. 14. FIG. 16 is a cross-sectional view taken along a plane including line XV-XV of FIG. 14. FIG. 17 is a cross-sectional view taken along a plane including line XVI-XVI of FIG. 14. FIG. 18 is a cross-sectional view taken along a plane including line XVII-XVII of FIG. 14. FIG. 19 is a cross-sectional view taken along a plane including line XVIII-XVIII of FIG. 14. In FIGS. 15 through 18, broken lines indicate cutting positions in a cutting process.

An imprinting apparatus 10B forms the concavo-convex layer (first concavo-convex layer) 17 and a second concavo-convex layer 18 on the glass sheet 11 (FIG. 18). The first and second concavo-convex layers 17 and 18 are formed on the opposite sides across the glass sheet 11. The glass sheet 11 and the first and second concavo-convex layers 17 and 18 form a laminated sheet 19B. Each of the first and second concavo-convex layers 17 and 18 has a concavo-convex pattern of periodically arranged elevations. The concavo-convex pattern of the first concavo-convex layer 17 and the concavo-convex pattern of the second concavo-convex layer 18 may be the same or different.

The imprinting apparatus 10B includes the applicator (first applicator) 31, a second applicator 32, the light source 35, a couple of feed rollers 45 (only one of which is illustrated in FIG. 14), the superposing rollers 46 and 47, the wind-up roller 48, and the laminated sheet cutter 49.

Unlike the imprinting apparatus 10 of the first embodiment, the imprinting apparatus 10B includes first and second endless belt-shaped molds 33B and 34B, multiple (for example, two) rotating rollers 41B and 42B, and multiple (for example, two) nip rollers 43B and 44B.

The first mold 33B has a concavo-convex pattern to be transferred to a surface of the first forming material layer 15. Likewise, the second mold 34B has a concavo-convex pattern to be transferred to a surface of the second forming material layer 16. The first and second molds 33B and 34B may be subjected to mold release treatment in order to increase the releasability of the forming material from the mold surface.

The first mold 33B is wrapped around the rotating rollers 41B and 42B and multiple auxiliary rollers 61B and 62B so as to rotate. One or more of the auxiliary rollers 61B and 62B may be omitted.

The second mold 34B is wrapped around the rotating rollers 43B and 44B and multiple auxiliary rollers 63B and 64B so as to rotate. One or more of the auxiliary rollers 63B and 64B may be omitted.

The light source 35 emits light onto the first forming material layer 15 held between the glass sheet 11 and the first mold 33B so as to solidify the first forming material layer 15. Furthermore, the light source 35 emits light onto the second forming material layer 16 held between the glass sheet 11 and the second mold 34B so as to solidify the second forming material layer 16.

The light exiting from the light source 35 is transmitted through the transparent second mold 34B, the second forming material layer 16, and the transparent glass sheet 11 in this order to enter the first forming material layer 15. Alternatively, the light exiting from the light source 35 may be transmitted through the transparent first mold 33B, the first forming material layer 15, and the transparent glass sheet 11 in this order to enter the second forming material layer 16. As another alternative, multiple light sources may be employed.

The second mold 34B, the second forming material layer 16, the glass sheet 11, the first forming material layer 15, and the first mold 33B are held in this order from the nip roller 43B side and delivered by the rotating roller 41B and the nip roller 43B.

As illustrated in FIG. 14, the glass sheet 11 and the first mold 33B hold the first forming material layer 15 with the tension of the glass sheet 11 and the tension of the first mold 33B and move together with the first forming material layer 15 until being pulled out from between the rotating roller 42B and the nip roller 44B after being inserted between the rotating roller 41B and the nip roller 43B. During this time, the first forming material layer 15 is exposed to light from the light source 35 so as to gradually solidify and become the first concavo-convex layer 17. The direction of the tension of the glass sheet 11 is a direction in which the glass sheet 11 moves. The direction of the tension of the first mold 33B is a direction in which the first mold 33B moves (rotates).

Likewise, the glass sheet 11 and the second mold 34B hold the second forming material layer 16 with the tension of the glass sheet 11 and the tension of the second mold 34B and move together with the second forming material layer 16 until being pulled out from between the rotating roller 42B and the nip roller 44B after being inserted between the rotating roller 41B and the nip roller 43B. During this time, the first second material layer 16 is exposed to light from the light source 35 so as to gradually solidify and become the second concavo-convex layer 18. The direction of the tension of the glass sheet 11 is a direction in which the glass sheet 11 moves. The direction of the tension of the second mold 34B is a direction in which the second mold 34B moves (rotates).

The second mold 34B, the second concavo-convex layer 18, the glass sheet 11, the first concavo-convex layer 17, and the first mold 33B are held in this order from the nip roller 44B side and delivered by the rotating roller 42B and the nip roller 44B.

Next, a description is given of operations (an imprinting method) of the imprinting apparatus 10B of the above-described configuration. Various operations of the imprinting apparatus 10B are performed under the control of a controller that includes a microcomputer. In the following description, various operations of the imprinting apparatus 10B are described mainly with reference to part of the glass sheet 11 for convenience of description.

First, as illustrated in FIG. 15, the first and second applicators 31 and 32 apply the forming material on both sides of the glass sheet 11 successively fed from a glass forming apparatus, so that the first and second forming material layers 15 and 16 are formed.

The first and second applicators 31 and 32 apply the forming material to positions distant from the cutting positions of the laminated sheet cutter 49. That is, the first and second applicators 31 and 32 do not apply the forming material to the cutting positions of the laminated sheet cutter 49 and their vicinity. For example, the first and second applicators 31 and 32 apply the forming material inside the widthwise ends of the thin part 11-3. The widths of the first and second forming material layers 15 and 16 are narrower than the width of the thin part 11-3. The first applicator 31 and the second applicator 32 may have the same configuration.

Next, as illustrated in FIG. 16, the second mold 34B, the second forming material layer 16, the glass sheet 11, the first forming material layer 15, and the first mold 33B are held in this order from the nip roller 43B side and delivered by the rotating roller 41B and the nip roller 43B.

As illustrated in FIG. 14, the glass sheet 11 and the first forming material layer 15 are in a flat state when inserted between the rotating roller 41B and the nip roller 43B. On the other hand, the first mold 33B is inserted between the rotating roller 41B and the nip roller 43B while being bent and deformed along the rotating roller 41B so as not to bite in air between the first forming material layer 15 and the first mold 33B, so as to come into close contact with the first forming material layer 15.

As illustrated in FIG. 17, the glass sheet 11 and the first mold 33B hold the first forming material layer 15 with the tension of the glass sheet 11 and the tension of the first mold 33B and move together with the first forming material layer 15 until being pulled out from between the rotating roller 42B and the nip roller 44B after being inserted between the rotating roller 41B and the nip roller 43B. During this time, the first forming material layer 15 is exposed to light from the light source 35 so as to gradually solidify and become the first concavo-convex layer 17.

Furthermore, as illustrated in FIG. 14, the glass sheet 11 and the second forming material layer 16 are in a flat state when inserted between the rotating roller 41B and the nip roller 43B. On the other hand, the second mold 34B is inserted between the rotating roller 41B and the nip roller 43B while being bent and deformed along the nip roller 43B so as not to bite in air between the second forming material layer 16 and the second mold 34B, so as to come into close contact with the second forming material layer 16.

As illustrated in FIG. 17, the glass sheet 11 and the second mold 34B hold the second forming material layer 16 with the tension of the glass sheet 11 and the tension of the second mold 34B and move together with the second forming material layer 16 until being pulled out from between the rotating roller 42B and the nip roller 44B after being inserted between the rotating roller 41B and the nip roller 43B. During this time, the second forming material layer 16 is exposed to light from the light source 35 so as to gradually solidify and become the second concavo-convex layer 18.

Next, the second mold 34B, the second concavo-convex layer 18, the glass sheet 11, the first concavo-convex layer 17, and the first mold 33B are held in this order from the nip roller 44B side and delivered by the rotating roller 42B and the nip roller 44B.

As illustrated in FIG. 14, the glass sheet 11 and the first concavo-convex layer 17 are pulled out from between the rotating roller 42B and the nip roller 44B while being in a flat state. On the other hand, the first mold 33B is bent and deformed along the rotating roller 42B for smooth separation from the first concavo-convex layer 17.

Likewise, the glass sheet 11 and the second concavo-convex layer 18 are pulled out from between the rotating roller 42B and the nip roller 44B while being in a flat state. On the other hand, the second mold 34B is bent and deformed along the nip roller 44B for smooth separation from the second concavo-convex layer 18.

Thus, the laminated sheet 19B including the glass sheet 11 and the first and second concavo-convex layers 17 and 18 is obtained as illustrated in FIG. 18. The first and second concavo-convex layers 17 and 18 are formed inside the widthwise ends of the thin part 11-3, and are formed at positions distant from the cutting positions of the laminated sheet cutter 49.

Accordingly, by cutting the glass sheet 11 alone, the laminated sheet cutter 49 can cut the laminated sheet 19B without cutting the first and second concavo-convex layers 17 and 18 that greatly differ in hardness from the glass sheet 11. It is possible to employ a commonly used glass cutting method as a method of cutting the laminated sheet 19B, so that it is possible to cut the laminated sheet 19B with ease and accuracy.

The laminated sheet cutter 49 cuts off the thick parts 11-1 and 11-2 of the glass sheet 11 by cutting the glass sheet 11 as illustrated in FIG. 19, for example. At this time, the laminated sheet cutter 49 may cut off part of the thin part 11-3 together with the thick parts 11-1 and 11-2.

Next, the superposing rollers 46 and 47 superpose the concavo-convex protection sheets 13 fed out from two protection sheet rolls and the laminated sheet 19B on top of each other. The concavo-convex protection sheets 13 are formed of a resin film, paper or the like. The concavo-convex protection sheets 13 (only one of which is illustrated in FIG. 14) cover the first and second concavo-convex layers 17 and 18 so as to prevent adhesion of foreign matter such as dust or damage to the first and second concavo-convex layers 17 and 18.

Next, the wind-up roller 48 winds up a lamination of the laminated sheet 19B and the concavo-convex protection sheets 13 provided one on each side of the laminated sheet 19B so as to produce a product roll. Because the thick parts 11-1 and 11-2 of the glass sheet 11 are cut off, a gap is less likely to be formed inside the product roll, so that it is possible to prevent the product roll from losing shape. Furthermore, the internal stress of the product roll is less likely to be uneven, so that the glass sheet 11 is less likely to be broken.

According to this embodiment, the applicators 31 and 32 apply the forming material to positions distant from the cutting positions of the laminated sheet cutter 49 as in the first embodiment. By cutting the glass sheet alone, the laminated sheet cutter 49 can cut the laminated sheet 19B without cutting the first and second concavo-convex layers 17 and 18 that greatly differ in hardness from the glass sheet 11. Accordingly, it is possible to employ a commonly used glass cutting method as a method of cutting the laminated sheet 19B, so that it is possible to cut the laminated sheet 19B with ease and accuracy.

Furthermore, according to this embodiment, the laminated sheet cutter 49 cuts off the thick parts 11-1 and 11-2 of the glass sheet 11 by cutting the laminated sheet 19B. Because the thin part 11-3 uniform in thickness is wound up by the wind-up roller 48, a gap is less likely to be formed inside the product roll, so that it is possible to prevent the product roll from losing shape. Furthermore, the internal stress of the product roll is less likely to be uneven, so that the glass sheet 11 is less likely to be broken.

Furthermore, according to this embodiment, the glass sheet 11 passes between the rotating rollers 41B and 42B and the nip rollers 43B and 44B while being in a flat state. Therefore, the brittle glass sheet 11 is kept flat at the time of transfer of the concavo-convex patterns of the first and second molds 33B and 34B and at the time of separation of the first and second molds 33B and 34B and the first and second concavo-convex layers 17 and 18. Accordingly, it is possible to further prevent the breakage of the glass sheet 11.

Furthermore, according to this embodiment, because the first and second forming material layers 15 and 16 are formed on the opposite sides across the glass sheet 11, the glass sheet 11 is less likely to warp at the time of solidification of the forming material. Furthermore, because a force to separate the first concavo-convex layer 17 and the first mold 33B and a force to separate the second concavo-convex layer 18 and the second mold 34B act in directions opposite to each other, the state of the glass sheet 11 is stabilized. Furthermore, the first concavo-convex layer 17 and the second concavo-convex layer 18 are simultaneously formed. Therefore, unlike in the case of forming concavo-convex layers separately, no alignment is necessary.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Imprinting methods and apparatuses are described above based on the first through third embodiments. It should be understood, however, that the present invention is not limited to the specifically disclosed embodiments, and various changes, substitutions, and alterations could be made hereto without departing from the spirit and scope of the invention.

For example, while the imprinting apparatus forms a concavo-convex layer on a glass sheet successively fed from a glass forming apparatus according to the above-described embodiments, the imprinting apparatus may alternatively form a concavo-convex layer on a glass sheet fed from a glass roll into which a glass sheet is spirally rolled up.

Furthermore, while the imprinting apparatus winds up a laminated sheet including a glass sheet and a concavo-convex layer with the wind-up roller 48 according to the above-described embodiments, the imprinting apparatus may alternatively cut the laminated sheet to a predetermined size with a laminated sheet cutter instead of winding up the laminated sheet.

Furthermore, while the imprinting apparatus is a photoimprinting apparatus according to the above-described embodiments, the imprinting apparatus may alternatively be a thermal imprinting apparatus. In this case, the forming material contains thermoplastic resin instead of a photopolymer. Common thermoplastic resins used for thermal imprinting, such as acrylic reins, polycarbonate resins, and olefin resins, may be used. The thermoplastic resin may be prepared in the form of a solution and be applied onto a glass sheet and dried. Alternatively, the thermoplastic resin may be softened by heating and thereafter be applied on a glass sheet and cooled. According to thermal imprinting, a concavo-convex layer is formed by softening a forming material layer containing thermoplastic resin by heating, pressing a mold against a surface of the softened forming material layer, and solidifying the forming material layer by cooling. As a heating source, a light source that emits heating light (such as a halogen lamp or a laser) or a heater is used. The heating temperature is the glass transition temperature of the thermoplastic resin or higher. The process of pressing the mold and the process of heating the forming material layer may be performed either one after the other or at the same time. The forming material layer may be heated by heating the mold.

Furthermore, while the applicator successively applies the forming material on a moving glass sheet according to the above-described embodiments, multiple forming material layers 15 may alternatively be formed at intervals in the moving direction (lengthwise direction) of the glass sheet 11 by applying the forming material intermittently on the moving glass sheet 11 as illustrated in FIG. 20. As a result, multiple concavo-convex layers are formed at intervals in the lengthwise direction of the glass sheet 11. Cutting a laminated sheet in a direction perpendicular (transverse) to the lengthwise direction between concavo-convex layers makes it possible to cut the laminated sheet by cutting the glass sheet alone. This cutting may be performed at a customer's end after shipment of a product roll. This is effective in the case of feeding a laminated sheet little by little from a product roll and cutting the laminated sheet little by little. For example, the applicator 31 includes a supply source 31-1 of a forming material, a discharge head 31-2 that discharges the forming material, a connecting pipe 31-3 that connects the supply source 31-1 and the discharge head 31-2, a pump 31-4 and a supply valve 31-5 that are provided in the middle of the connecting pipe 31-3, a circulation pipe 31-6 that connects a middle portion of the connecting pipe 31-3 and the supply source 31-1, and a circulation valve 31-7 provided in the middle of the circulation pipe 31-6. At the time of applying the forming material, the applicator 31 opens the supply valve 31-5, closes the circulation valve 31-7, and drives the pump 31-4, so as to supply the forming material from the supply source 31-1 to the discharge head 31-2. On the other hand, at the time of temporarily suspending application of the forming material, the applicator 31 closes the supply valve 31-5 and opens the circulation valve 31-7 while keeping on driving the pump 31-4, so as to return the forming material delivered from the pump 31-4 to the supply source 31-1 through the circulation pipe 31-6.

Furthermore, while the applicator successively applies the forming material in the widthwise directions of a glass sheet (lateral directions in FIG. 3) according to the above-described embodiments, the applicator may alternatively apply the forming material at intervals in the widthwise directions of a glass sheet. It is possible to form multiple concavo-convex layers at intervals in the widthwise directions of a glass sheet. Cutting a laminated sheet parallel to the lengthwise direction (lengthwise) between concavo-convex layers makes it possible to cut the laminated sheet by cutting the glass sheet alone. This cutting may be performed at a customer' end after shipment of a product roll.

Furthermore, while the applicator applies the forming material on a glass sheet according to the above-described embodiments, the applicator may alternatively apply the forming material on a mold or on both the glass sheet and the mold. In the transfer process, the forming material layer is held between the glass sheet and the mold so that the concavo-convex pattern of the mold is transferred to the forming material layer. In the case of applying the forming material layer on the mold, the applicator may apply the forming material at a position distant from positions corresponding to the cutting positions of the laminated sheet cutter. Furthermore, the applicator may apply the forming material at intervals along the periphery of a roll-shaped or endless belt-shaped mold. Furthermore, the applicator may form multiple forming material layers at intervals in directions corresponding to the widthwise directions of a belt-shaped glass sheet.

Furthermore, while the laminated sheet cutter cuts off thick parts at both widthwise ends of a glass sheet according to the above-described embodiments, the laminated sheet cutter may alternatively cuts a glass sheet of which thick parts have been cut off.

Furthermore, according to the above-described first and second embodiments, the axial length L of contact rollers (including the transfer roller 43, the separation roller 44, the nip rollers 43A and 44A) that come into contact with the resin film 12 in the transfer process is greater than the width W of the glass sheet 11. Alternatively, however, the axial length L may be smaller than the width W. That is, in a view in a thickness direction of the glass sheet 11, the contact rollers may be provided between the thick parts 11-1 and 11-2 without projecting from the thin part 11-3. It is possible to ensure prevention of the contact of the thick parts 11-1 and 11-2 and the contract rollers irrespective of the width of the resin film 12 and to ensure filling in the gap between the thin part 11-3 and the contact rollers. In this case, because the width of the resin film 12 does not matter, the resin film 12 may be bonded to both the thick parts 11-1 and 11-2 and the thin part 11-3.

Furthermore, while a concavo-convex layer and a mold are separated after solidification of the forming material in the transfer process according to the above-described embodiments, the forming material may alternatively be solidified after separation of the concavo-convex layer and the mold.

What is claimed is:

1. An imprinting method, comprising:
applying a forming material onto a glass sheet;
forming a concavo-convex layer on the glass sheet by holding a layer of the forming material between the glass sheet and a mold and transferring a concavo-convex pattern of the mold to the layer of the forming material; and
cutting a laminated sheet including the glass sheet and the concavo-convex layer,
wherein, in said applying, the forming material is applied to a position distant from a cutting position of said cutting.

2. The imprinting method as claimed in claim 1,
wherein the glass sheet has a belt shape and includes first and second thick parts and a thin part between the first and second thick parts, the first and second thick parts forming first and second widthwise end portions, respectively, of the glass sheet, the thin part being thinner than the first and second thick parts and having a uniform thickness, and
wherein the first and second thick parts of the glass sheet are cut off by cutting the laminated sheet in said cutting.

3. The imprinting method as claimed in claim 1,
wherein the mold has an endless belt shape and is wrapped around a plurality of first rollers, the first rollers being paired with corresponding second rollers, and the mold is rotated so that the glass sheet in a flat state and the mold pass between the first rollers and the second rollers, and
wherein the glass sheet and the mold hold the layer of the forming material and transfer the concavo-convex pattern of the mold to the layer of the forming material until being pulled out from between the first and second rollers of a first pair after being inserted between the first and second rollers of a second pair.

4. The imprinting method as claimed in claim 1,
wherein the mold has an endless belt shape and is wrapped around a plurality of first rollers, the first rollers being paired with corresponding second rollers, and the mold and an additional mold having the endless belt shape and wrapped around the second rollers are rotated so that the glass sheet in a flat state, the mold and the additional mold pass between the first rollers and the second rollers,
wherein the glass sheet and the mold hold the layer of the forming material and transfer the concavo-convex pattern of the mold to the layer of the forming material until being pulled out from between the first and second rollers of a first pair after being inserted between the first and second rollers of a second pair, and
wherein the glass sheet and the additional mold hold an additional layer of the forming material and transfer a concavo-convex pattern of the additional mold to the additional layer of the forming material until being pulled out from between the first and second rollers of the first pair after being inserted between the first and second rollers of the second pair.

5. An imprinting method, comprising:
applying a forming material onto a glass sheet having a belt shape; and
forming a concavo-convex layer on the glass sheet by holding a layer of the forming material between the glass sheet and a mold and transferring a concavo-convex pattern of the mold to the layer of the forming material,
wherein the forming material is applied at intervals in a lengthwise direction of the glass sheet in said applying.

6. The imprinting method as claimed in claim 5,
wherein the mold has an endless belt shape and is wrapped around a plurality of first rollers, the first rollers being paired with corresponding second rollers, and the mold is rotated so that the glass sheet in a flat state and the mold pass between the first rollers and the second rollers, and
wherein the glass sheet and the mold hold the layer of the forming material and transfer the concavo-convex pattern of the mold to the layer of the forming material until being pulled out from between the first and second rollers of a first pair after being inserted between the first and second rollers of a second pair.

7. The imprinting method as claimed in claim 5,
wherein the mold has an endless belt shape and is wrapped around a plurality of first rollers, the first rollers being paired with corresponding second rollers, and the mold and an additional mold having the endless belt shape and wrapped around the second rollers are rotated so that the glass sheet in a flat state, the mold and the additional mold pass between the first rollers and the second rollers,
wherein the glass sheet and the mold hold the layer of the forming material and transfer the concavo-convex pattern of the mold to the layer of the forming material until being pulled out from between the first and second rollers of a first pair after being inserted between the first and second rollers of a second pair, and
wherein the glass sheet and the additional mold hold an additional layer of the forming material and transfer a concavo-convex pattern of the additional mold to the additional layer of the forming material until being pulled out from between the first and second rollers of the first pair after being inserted between the first and second rollers of the second pair.

8. An imprinting method, comprising:
applying a forming material onto a mold;
forming a concavo-convex layer on a glass sheet by holding a layer of the forming material between the mold and the glass sheet and transferring a concavo-convex pattern of the mold to the layer of the forming material; and
cutting a laminated sheet including the glass sheet and the concavo-convex layer,
wherein, in said applying, the forming material is applied to a position distant from a position on the mold corresponding to a cutting position of the glass sheet in said cutting.

9. The imprinting method as claimed in claim 8,
wherein the glass sheet has a belt shape and includes first and second thick parts and a thin part between the first and second thick parts, the first and second thick parts forming first and second widthwise end portions, respectively, of the glass sheet, the thin part being thinner than the first and second thick parts and having a uniform thickness, and
wherein the first and second thick parts of the glass sheet are cut off by cutting the laminated sheet in said cutting.

10. An imprinting method, comprising:
applying a forming material onto a mold having a roll shape or an endless belt shape; and
forming a concavo-convex layer on a glass sheet by holding a layer of the forming material between the mold and the glass sheet and transferring a concavo-convex pattern of the mold to the layer of the forming material,
wherein the forming material is applied at intervals along a periphery of the mold in said applying.

11. An imprinting apparatus, comprising:
an applicator that applies a forming material onto a glass sheet;
a mold having a concavo-convex pattern; and
a cutter that cuts a laminated sheet including the glass sheet and a concavo-convex layer, the concavo-convex layer being formed by holding a layer of the forming material between the glass sheet and the mold and transferring the concavo-convex pattern of the mold to the layer of the forming material,
wherein the applicator applies the forming material to a position distant from a cutting position of the cutter.

12. The imprinting apparatus as claimed in claim 11,
wherein the glass sheet has a belt shape and includes first and second thick parts and a thin part between the first and second thick parts, the first and second thick parts forming first and second widthwise end portions, respectively, of the glass sheet, the thin part being thinner than the first and second thick parts and having a uniform thickness, and
wherein the cutter cuts off the first and second thick parts of the glass sheet by cutting the laminated sheet.

13. The imprinting apparatus as claimed in claim 11, further comprising:
a plurality of first rollers paired with corresponding second rollers, the first and second rollers passing the glass sheet in a flat state,
wherein the mold has an endless belt shape and is wrapped around the first rollers, and
wherein the glass sheet and the mold hold the layer of the forming material and transfer the concavo-convex pattern of the mold to the layer of the forming material until being pulled out from between the first and second rollers of a first pair after being inserted between the first and second rollers of a second pair.

14. The imprinting apparatus as claimed in claim 11, further comprising:
an additional mold having an endless belt shape; and
a plurality of first rollers and a plurality of second rollers paired with the corresponding first rollers, the first and second rollers passing the glass sheet in a flat state,
wherein the mold has an endless belt shape and is wrapped around the first rollers, and the additional mold is wrapped around the second rollers,
wherein the glass sheet and the mold hold the layer of the forming material and transfer the concavo-convex pattern of the mold to the layer of the forming material until being pulled out from between the first and second rollers of a first pair after being inserted between the first and second rollers of a second pair, and
wherein the glass sheet and the additional mold hold an additional layer of the forming material and transfer a concavo-convex pattern of the additional mold to the additional layer of the forming material until being pulled out from between the first and second rollers of the first pair after being inserted between the first and second rollers of the second pair.

15. An imprinting apparatus, comprising:
an applicator that applies a forming material onto a glass sheet having a belt shape; and
a mold having a concavo-convex pattern,
wherein a concavo-convex layer is formed on the glass sheet by holding a layer of the forming material between the glass sheet and the mold and transferring the concavo-convex pattern of the mold to the layer of the forming material, and
wherein the applicator applies the forming material at intervals in a lengthwise direction of the glass sheet.

16. The imprinting apparatus as claimed in claim 15, further comprising:
a plurality of first rollers paired with corresponding second rollers, the first and second rollers passing the glass sheet in a flat state,
wherein the mold has an endless belt shape and is wrapped around the first rollers, and
wherein the glass sheet and the mold hold the layer of the forming material and transfer the concavo-convex pattern of the mold to the layer of the forming material until being pulled out from between the first and second rollers of a first pair after being inserted between the first and second rollers of a second pair.

17. The imprinting apparatus as claimed in claim 15, further comprising:
an additional mold having an endless belt shape; and
a plurality of first rollers and a plurality of second rollers paired with the corresponding first rollers, the first and second rollers passing the glass sheet in a flat state,
wherein the mold has an endless belt shape and is wrapped around the first rollers, and the additional mold is wrapped around the second rollers,
wherein the glass sheet and the mold hold the layer of the forming material and transfer the concavo-convex pattern of the mold to the layer of the forming material until being pulled out from between the first and second rollers of a first pair after being inserted between the first and second rollers of a second pair, and
wherein the glass sheet and the additional mold hold an additional layer of the forming material and transfer a concavo-convex pattern of the additional mold to the additional layer of the forming material until being pulled out from between the first and second rollers of the first pair after being inserted between the first and second rollers of the second pair.

18. An imprinting apparatus, comprising:
a mold having a concavo-convex pattern;
an applicator that applies a forming material onto the mold; and
a cutter that cuts a laminated sheet including a glass sheet and a concavo-convex layer, the concavo-convex layer being formed by holding a layer of the forming material between the mold and the glass sheet and transferring the concavo-convex pattern of the mold to the layer of the forming material,
wherein the applicator applies the forming material to a position distant from a position on the mold corresponding to a cutting position at which the glass sheet is cut by the cutter.

19. The imprinting apparatus as claimed in claim 18,
wherein the glass sheet has a belt shape and includes first and second thick parts and a thin part between the first and second thick parts, the first and second thick parts forming first and second widthwise end portions, respectively, of the glass sheet, the thin part being thinner than the first and second thick parts and having a uniform thickness, and
wherein the cutter cuts off the first and second thick parts of the glass sheet by cutting the laminated sheet.

20. An imprinting apparatus, comprising:
a mold having a concavo-convex pattern, the mold having a roll shape or an endless belt shape;
an applicator that applies a forming material onto the mold; and
a cutter that cuts a laminated sheet including a glass sheet and a concavo-convex layer, the concavo-convex layer being formed by holding a layer of the forming material between the mold and the glass sheet and transferring the concavo-convex pattern of the mold to the layer of the forming material,
wherein the applicator applies the forming material at intervals along a periphery of the mold.
